(19) United States
(12) Patent Application Publication
(10) Pub. No.: US 2007/0074765 A1
(43) Pub. Date: Apr. 5, 2007

(54) Valve for thermal-regenerative waste gas purification installation and waste gas purification installation

(75) Inventors: Rita Muller, Langenselbold (DE); Andreas Molnar, Grundau-Mittelgrundau (DE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Rita Muller I, Langenselbold (DE)

(21) Appl. No.: 11/241,826

(22) Filed: Sep. 30, 2005

(51) Int. Cl. F16K 23/00

(52) U.S. Cl. 137/312

(57) ABSTRACT

Valve for thermal-regenerative waste gas purification installation; may be installed in connecting duct of the installation, the duct connecting gas inlet duct or gas outlet duct for inlet or outlet of untreated or treated waste gas with treatment chamber, having conical valve seat and an obturator of corresponding shape, operative to close an orifice formed by the valve seat, wherein the obturator is connected with a stem for actuation of the obturator. The obturator may comprise upper obturator plate and lower obturator plate, mounted spaced apart from one another, the stem comprising an axial internal bore, which is connected with a space between the obturator plates, in order to connect the space directly with the outside environment or with an external fan or air compressor.

### TECHNICAL FIELD

The present invention relates to a valve for a thermal-regenerative waste gas purification installation and to a thermal-regenerative waste gas purification installation comprising at least one such valve.

### BACKGROUND OF THE INVENTION

Such waste gas purification installations are used for removing volatile substances containing hydrocarbons and further volatile organic constituents, such as for example odours, from waste gases or the waste air from industrial or workshop processes or installations. The temperature of the waste gases or waste air containing the volatile organic substances is here raised by use of a suitable heat exchanger, before these gases are introduced into a combustion chamber at a temperature of about 750° C., in order to perform thermal oxidation therein. In thermal-regenerative waste gas purification, the majority of the heat of combustion released on oxidation is stored in a solid storage medium, for example in a ceramic material. The stored heat is then taken up by the process or waste gas to be oxidised (in the following process cycle), wherein the heat exchanger serves solely for generating heat within the process. Depending on the concentration of the volatile organic substances in the process or waste gas and the temperature of the gas, the process proceeds autothermally or additional energy is required.

In order to ensure elevated efficiency and highly efficient waste gas purification, precise and continuous plant control is necessary, which, for the purposes of the present application, is effected by valves which, as explained below, are installed at appropriate points in the installation in order to shut off and control the flow of waste gas. The general mode of operation of thermal-regenerative waste gas purification installations is described, for example in U.S. Pat. No. 6,039,927.

Since waste gas purification installations of the above-stated kind are continuously operated, for example undergoing up to 200,000 cycles per year, the valves must be of a design which is very durable and capable of withstanding considerable loads. To this end, U.S. Pat. No. 6,039,927 discloses a twin rotary disk valve, the two rotary disks of which are push-pull controlled by an eccentric drive. Rotary disk valves may, however, be problematic with regard to their tightness.

However, the ability to achieve a hermetic seal even over extended operation is necessary for optimum waste gas purification complying with future legal requirements. In particular, only by means of hermetically sealing valves is it possible to prevent carry-over of as yet untreated waste gases into a gas outlet duct of the waste gas purification installation. However, the use of sealing rings and the like in the valve seat has proved unsatisfactory for long-term operation in thermal-regenerative waste gas purification installations, in particular also because long replacement intervals are desired.

It is known that hermetically sealing valves may particularly simply be provided by provision of a conical valve seat in a valve housing which cooperates with a correspondingly conically shaped valve gate. The seal quality of valves in thermal-regenerative waste gas purification installations is impaired by dirt deposits and by mechanical damage in the area of the valve seat and of the associated obturator. Mechanical damage to the valve seat and/or obturator may also be the direct result of dirt deposits in these areas. Dirt deposits are known to have a tendency to accumulate locally, so further encouraging leaks in hermetically sealing valves.

In order to prevent dirt deposits in the area of a conical valve seat, FR 707,275 and FR 679,464 each discloses a conical valve seat into which open a plurality of radial bores which are connected with a fan or air compressor. Immediately before the valve closes, a flushing gas flows out from the radial bores into the annular gap between the obturator and the conical valve seat, in order to flush the valve seat and the obturator and remove dirt deposits.

EP 1 258 678 A2 discloses a related valve having a conical valve seat. A plurality of radial bores open in mutually spaced manner into the valve seat. In order also effectively to remove dirt deposits which are located further away from a bore on the valve seat and/or obturator, a circumferential groove is provided in the valve seat, in which a plurality of radial bores open and which distributes the flushing gas uniformly in the circumferential direction. The structure of the valve with a plurality of radial bores is, however, comparatively complex. If the plurality of radial bores is to be connected with an external fan, an elaborate pipe system is required. The action of the flushing gas during closure of the valve is also not uniform. This is because the flushing action is also influenced by the width of the annular gap between the valve seat and the obturator, such that the cleaning action of the flushing gas is also dependent on the position of the actuating member.

German utility model DE 201 18 418 U1 discloses a waste gas purification apparatus for the thermal and/or catalytic purification of waste air which contains combustible constituents. Disk valves are used for opening and closing an untreated gas duct and further chambers in the waste gas purification apparatus, the valve gates of which may be moved between a closed position and an open position by means of a moving apparatus. The disk valve comprises in each case an annular valve seat surrounding the inlet aperture and a circular disk-shaped valve gate covering the inlet aperture. Particles in the untreated gas stream may result in deposits in the area of the valve seat, which may impair the tightness of the disk valves. German patent application DE 197 20 205 A1 discloses a process and an installation for purifying waste gases containing nitrogen oxides. Raise/lower valves comparable with the disk valves according to German utility model DE 201 18 418 U1 are used in the installation.

U.S. Pat. No. 5,134,945 discloses a thermal-regenerative waste gas purification installation with valves of the flat slide design. Particles in the stream of untreated gas to be purified may likewise give rise to deposits in the area of the valve seat, as is the case with the above-stated types of valves, such that here too hermetic tightness of the valves cannot be ensured, in particular not in long-term operation.

WO 89/06763 discloses a process and device for protection and support of a seal in a valve arrangement. A circumferential seal is accommodated in a groove around the outer circumferential edge of the valve gate, said seal, when in the closed position, sealing against the valve seat. A locking element, virtually taking the form of an extension of the valve seat, is located above the valve seat. When the valve gate is moved into the open position to open the valve, the seal on the outer circumferential edge of the valve gate ultimately comes to rest against the locking element, such that, in the open position of the valve arrangement, the action of the valve seat in relation to the seal is replaced by the locking element. In this manner, the seal is also protected in the open position of the valve, for example also from deposits due to particles in the flow stream to be controlled. An embodiment is also disclosed with two circumferential seals, mutually spaced in the direction of displacement of the valve gate, on the outer circumferential edge of the valve gate, wherein a flow channel formed in the valve gate opens into the annular gap between the two circumferential seals for draining leaks and/or cleaning agent. However, as has been explained above, the use of sealing rings and the like in the valve seat is not satisfactory for the long-term operation of thermal-regenerative waste gas purification installations, in particular also because, according to the invention, the intention is to achieve long replacement intervals.

### SUMMARY OF THE INVENTION

It is an object of the present invention to provide, in straightforward and economic manner, a valve for a thermal-regenerative waste gas purification installation or plant. According to a further aspect of the present invention, the intention is to provide such a valve in which dirt deposits are uniformly removed from the valve seat. According to a further aspect of the present invention, the intention is also to provide a thermal-regenerative waste gas purification installation with at least one such valve.

The invention is based on a valve for a thermal-regenerative waste gas purification installation, which valve may be installed in the connecting duct of the waste gas purification installation, the duct connecting a gas inlet duct or gas outlet duct for inlet or outlet of an untreated or treated waste gas with a treatment chamber, having a conical valve seat and an obturator of corresponding shape, in order to close an orifice formed by the valve seat, the obturator being connected with an axially mobile stem for actuation of the obturator. According to the invention, the obturator comprises an upper obturator plate and a lower obturator plate, which are mounted spaced apart from one another, wherein the stem comprises an axial internal bore, which is connected with a space formed between the obturator plates, in order to connect the space directly with the outside environment or with an external fan or air compressor.

According to the invention, the valve seat comprises an advantageously simple structure, with a bevelled inner circumferential edge, in which no groove or the like need be formed. Production is accordingly straightforward, no burrs arise during production which could impair the tightness of the valve, and hermetic tightness of the valve is straightforwardly possible even over long-term operation. It is furthermore advantageous that only one single central bore, namely an internal bore in the valve stem, is sufficient to supply the valve seat with flushing air. Accordingly, no elaborate piping system is necessary in order to supply the valve seat with flushing air from an external fan or an air compressor.

Thanks to the preferably two-part structure of the obturator with two mutually spaced plates, the space can be very precisely controlled. In particular, the space may also be made very narrow, such that flushing air can be blown into the valve seat in a very controlled manner. When the obturator is actuated vertically, the entire area of the valve seat may furthermore be uniformly flushed, such that dirt deposits and the like may be removed still more effectively from the valve seat. Due to gravity, dirt deposits will usually be deposited on the obliquely downwardly inclined inner circumferential edge of the valve seat, but not, however, on the bevelled circumferential edges of the obturator plates. The flushing air which emerges radially outwards from the space between the two obturator plates is thus sufficient to remove dirt deposits from the area of the valve.

In the case of waste gas purification installations operated under reduced pressure, the space furthermore particularly effectively contributes to the hermetic tightness of the valve. This is because the space connected via the internal bore of the valve stem with the outside environment or with an external fan or an air compressor is at a certain overpressure both relative to the zone above of the obturator and relative to the zone below the obturator, i.e. relative to the gas inlet duct or gas outlet duct. Thus, in the event of any leaks at the circumferential edge of the upper and/or lower obturator plate, flushing air will flow out from the space via the leak into the zone above the obturator and/or below the obturator, such that any direct gas exchange between the zones above and below the obturator is effectively ruled out. Accordingly, even in the event of any dirt deposits and/or mechanical damage, any unwanted carry-over of untreated waste gases can effectively be prevented with the valve according to the invention. The flow resistance of the space may here be predetermined in an advantageously simple manner by suitable selection of the height of the space.

The space may be supplied with flushing air by providing an orifice at a lower end of the stem, which projects out from the gas inlet duct or gas outlet duct, in order to connect the internal bore of the valve stem with the outside environment or with the external fan or air compressor. This orifice may be provided directly in the circumferential wall of the valve stem or be formed directly by the internal bore of the valve stem.

According to a further embodiment, a cover plate may be provided at the lower end of the stem, in which cover plate the orifice is formed, preferably at the center thereof.

According to a further embodiment, the cover plate at the lower end of the valve stem is formed from a hardened metal, such that a cam-like, vertically mobile actuating element may be used to actuate the valve stem and the obturator. This enables central control of two or more valves by means of a single, rotatably mounted drive shaft which drives a plurality of cam-like actuating elements.

The valve stem or the cover plate located at the lower end thereof is preferably permanently pressed by the action of gravity against the mobile actuating element. According to a preferred embodiment, the actuating element cooperates with the lower end of the valve stem or the cover plate in such a manner that, when the valve stem is actuated, a rotary motive force is generated which slowly rotates the stem and the obturator connected therewith. It is advantageous that the valve seat and the obturator formed from the plates are more uniformly worn. Furthermore, the slow rotational movement prevents the same areas of the valve seat and the obturator plates from always coming to rest against one another in order to close the orifice in the valve seat. It is thus possible according to the invention to avoid mechanical damage, material defects and the like from becoming locally ever more pronounced until the valve begins to leak in zones where the mechanical damage, material defects and the like have become very greatly magnified over long-term use.

In order to bring about this rotational movement, the actuating element may cooperate eccentrically with the lower end of the valve stem or the cover plate, and/or bevelled and/or curved surfaces may be provided on the lower end of the valve stem or the cover plate or on the top of the actuating element.

According to a further embodiment, a roller or rolling member is provided on the top of the actuating element in order to bring about the above-stated rotational movements of the valve stem and the obturator.

According to a further embodiment, at least one orifice to connect the internal bore with the space is provided at the upper end of the valve stem, where the stem is connected with the two obturator plates, for example by means of a sleeve-like connecting element. These orifices may take the form, for example, of circumferential slots. According to a preferred modification, it is sufficient to provide a single orifice at the upper end of the valve stem, so further reducing production costs.

According to a further embodiment, the obturator plates are connected to one another by means of a plurality of connecting elements, which are arranged in the space close to the circumferential edges of the obturator plates. Because the obturator plates can flex only very slightly over the short distance between the externally arranged connecting elements and the outer circumferential edges, it is advantageous that the positional relationship between the bevelled circumferential edges of the obturator plates may be precisely predetermined, such that hermetic tightness of the valve may straightforwardly be achieved.

According to a further embodiment, the plurality of connecting elements are arranged in a point-symmetrical manner relative to the stem, such that any stresses or mechanical loads may be distributed uniformly over the obturator and the positional relationship of the circumferential edges which are important for the hermetic tightness of the valve can remain virtually unchanged.

According to a further aspect of the present invention, a thermal-regenerative or thermal-recuperative waste gas purification installation is additionally provided, which is distinguished by at least one valve according to the invention which is hermetically tight in order to suppress undesired carry-over of untreated waste gas or waste air into the gas outlet duct.

The valves are preferably driven by means of a central drive shaft, in order suitably to shut off or control waste gas flow in the waste gas purification installation.

### BRIEF DESCRIPTION OF THE DRAWINGS

The invention is described below by way of example with reference to the attached drawings, from which arise further features, advantages and problems to be solved and in which:

FIG. 1 shows a schematic side view of a thermal-regenerative waste gas purification installation according to the present invention;

FIG. 2 shows a schematic sectional view of a valve according to the present invention;

FIG. 3 shows a schematic plan view of the valve according to FIG. 2;

FIG. 4 shows a schematic partial section of a portion of the waste gas purification installation according to the FIG. 1, in order to explain operation of the valve according to FIG. 2;

FIG. 5 shows a schematic front view of the waste gas purification installation according to FIG. 1; and

FIG. 6 shows a schematic partial section of an enlarged portion of FIG. 4, in order to explain how the valve stem is actuated.

Throughout the Figures, identical reference numerals denote identical or substantially identically acting (equivalent) elements or groups of elements.

### DETAILED DESCRIPTION OF PREFERRED EXEMPLARY EMBODIMENTS

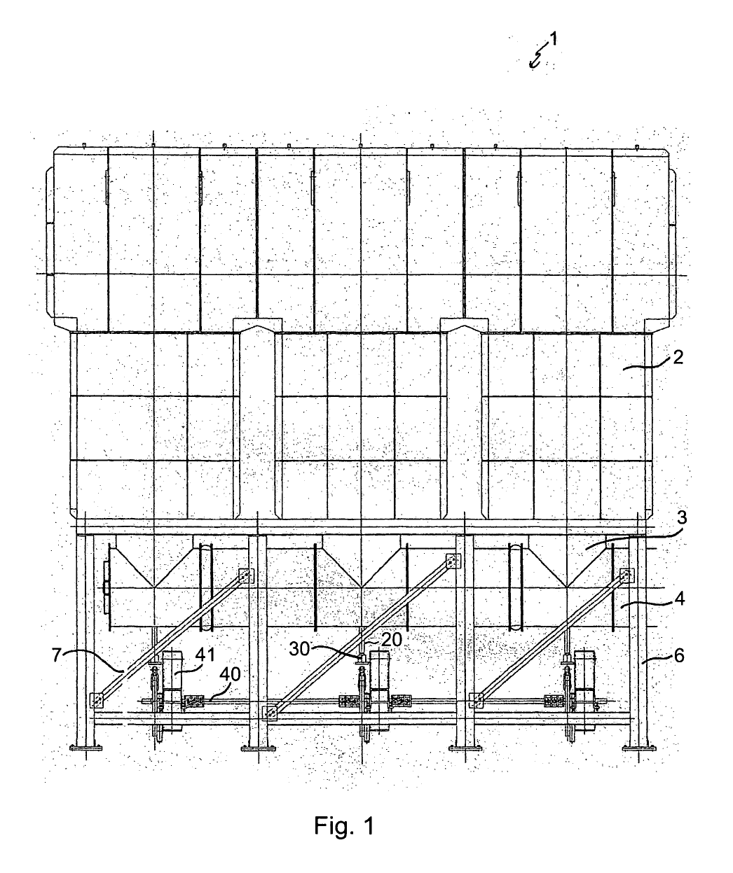

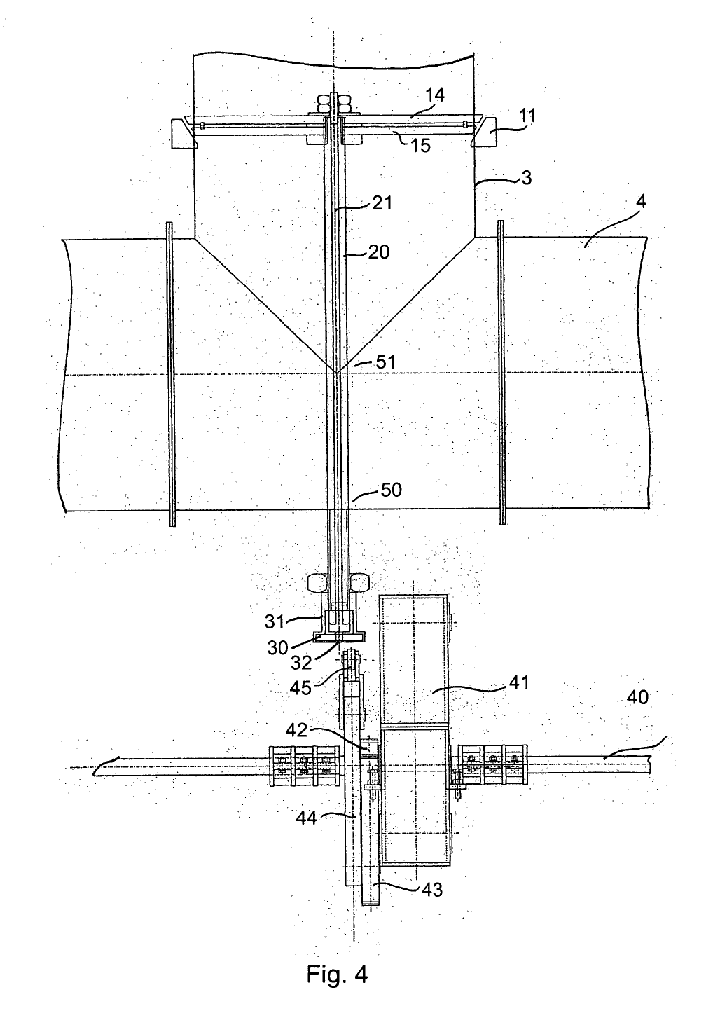

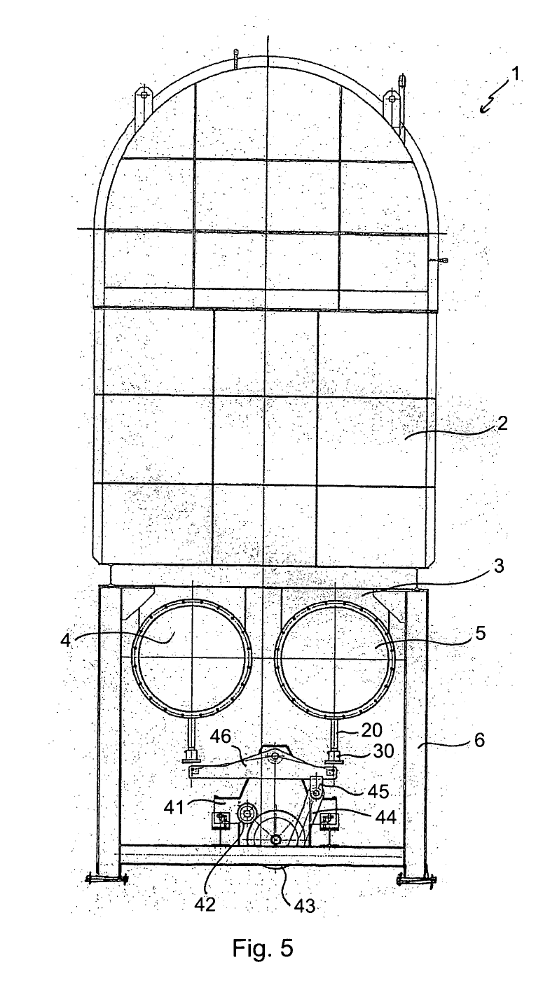

FIG. 1 shows a schematic side view of a thermal-regenerative waste gas purification installation according to the present invention. According to FIG. 1, the waste gas purification installation 1 comprises a plurality of, preferably an uneven number of, treatment chambers 2, which are connected via a respective vertical connecting duct 3 with a gas inlet duct 4 or a gas outlet duct 5 (c.f. FIG. 5). Beneath the gas inlet duct 4 there are arranged a plurality of pedestals 41, each associated with a particular treatment chamber 2, on which pedestals are mounted a central drive shaft 40 and a respective transmission for converting the rotational motion of the drive shaft 40 into a vertical actuating force for raising and lowering the valve stems 20, this being described in greater detail below with reference to FIGS. 4-6.

As shown in FIG. 4, a lower end of the valve stem 20 projects out from the gas inlet duct 4. The valve stem 20 is mounted for movement in sealing bushes (c.f. FIG. 4) in order to open and close the valve 10 by raising and lowering the two obturator plates 14, 15 which form an obturator. In this manner, waste gas flow may be shut off and controlled in the waste gas purification installation. As shown in FIG. 4, the valve, designated overall as 10, is fitted in a vertical connecting duct 3, specifically in the transitional zone between the associated gas inlet duct 4 (or gas outlet duct 5) and the associated treatment chamber.

As shown in FIG. 1, the waste gas purification installation 1 is supported on a frame 6, which is braced with cross struts 7 and the height of which is selected such that the drive 41 for actuating the valve stems 20 may be arranged directly below the waste gas purification installation 1 and maintenance work may also be carried out straightforwardly beneath the waste gas purification installation.

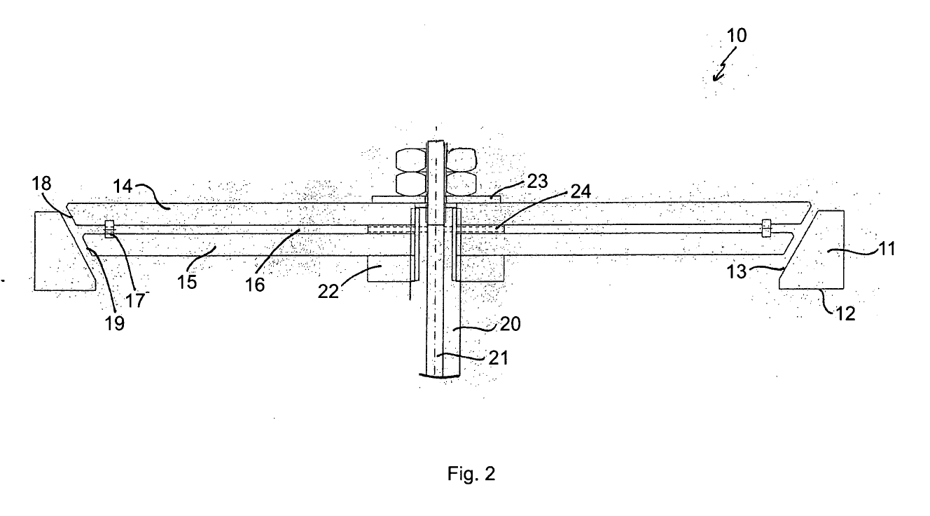

As shown in FIG. 2, the valve 10 comprises a valve seat 11, an obturator formed in the embodiment shown from two obturator plates 14, 15 and the valve stem 20 for raising and lowering the obturator in order to open and close the orifice formed by the valve seat 11. The valve seat 11 is fitted tightly in the vertical connecting duct 3 by means of flange connections (not shown). The valve seat 11 comprises a flat underside 12 to connect, accommodate or form a flange, and a valve seat face 13 which faces obliquely upwards at an acute angle, amounting in the exemplary embodiment shown to about 60 degrees. The valve seat face 13 forms an upwardly open, conical valve seat, with a flat, featureless inner circumferential edge, which faces obliquely upwards.

The valve obturator comprises two obturator plates 14, 15 arranged in parallel, which are rigidly connected to one another by means of connecting elements 17. A narrow space or gap 16 is formed between the two obturator plates 14, 15, the height of which is predetermined by the connecting elements 17 and, in the example shown, is distinctly less than the thickness of the obturator plates 14, 15. The outer circumferential edges 18, 19 of the obturator plates 14, 15 are shaped to correspond to the opposing bevelled valve seat face 13, such that the orifice formed by the valve seat 11 may be hermetically shut off when the valve stem 20 is lowered to such an extent that the outer circumferential edges 18, 19 rest directly against the valve seat face 13. When the valve stem 20 is raised further, an annular gap is formed between the outer circumferential edges 18, 19 and the opposing valve seat face 13, the width of which gap depends on the vertical position of the valve stem 20.

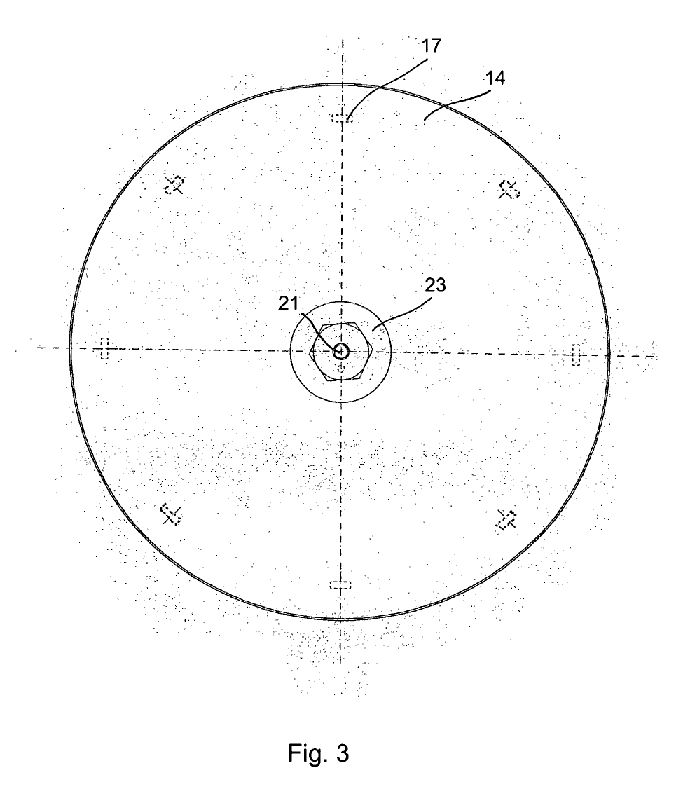

According to FIG. 2, the connecting elements 17 are arranged close to the circumferential edges 18, 19 of the obturator plates 14, 15, such that the relative positional relationship of the circumferential edges 18, 19 is virtually unchanged by mechanical loads, stresses, bending moments and the like. As may be seen in the schematic plan view according to FIG. 3, the connecting elements 17 are arranged in a point-symmetrical arrangement relative to the internal bore 21 of the valve stem, such that stresses are uniformly distributed over the obturator plates. Overall, the thickness of the obturator plates 14, 15 (c.f. FIG. 2) is selected to be sufficient for the obturator plates 14, 15 to flex, albeit negligibly, over the diameter of the orifice formed by the valve seat 11 and to provide a hermetic seal for the valve 10.

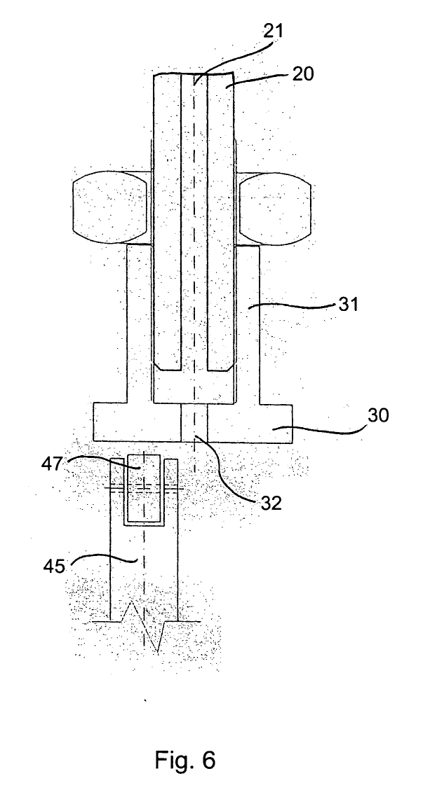

According to FIG. 2, the valve stem 20 is rigidly connected by means of a cylindrical connecting element 22 with the two obturator plates 14, 15. Above the valve stem 20, there is located on the top of the upper obturator plate 14 a plate 23 for weighting the obturator. According to FIG. 2, the valve stem 20 comprises an axial internal bore 21, which, as shown in FIG. 6, extends down to the lower end of the valve stem 20, where an orifice 32 is provided, in order to connect the internal bore 21 with the outside environment (at atmospheric pressure) or with an external fan or air compressor. As shown in FIG. 2, radial bores 24 open into the axial internal bore 21 of the valve stem 20, such that the space 16 is connected via the radial bores 24, the axial internal bore 21 and the orifice at the lower end of the valve stem 20 with the outside environment or with the external fan or air compressor. Flow resistance may be suitably predetermined by suitable selection of the diameter of the orifice at the lower end of the valve stem, the axial internal bore 21 and the radial bore 24 and the height of the space or gap 16. Although FIG. 2 shows a plurality of radial bores 24 in the connecting element 22, it is preferred according to the invention to provide only one orifice in the connecting element 22, for example a substantially rectangular circumferential slot, as a particularly simple mechanical structure of the valve 10 may be achieved in this manner.

Hermetically sealed seating of the obturator is achieved in the shut off position of the valve 10, in which the bevelled outer circumferential edges 18, 19 rest directly against the bevelled valve seat face 13. Even in the event of any mechanical damage to the bevelled valve seat face 13 and/or to the outer circumferential edges 18, 19, this hermetic tightness may be retained according to the invention in the following manner. According to the invention, the waste gas purification installation is preferably operated under a considerably reduced pressure, such that an under pressure prevails above and below the valve 10 which amounts to less than approx. 0.1 bar and preferably to approx. 40 to 60 mbar. A considerable pressure difference thus prevails according to the invention relative to the space 16, which is connected via the radial bores 24, the axial internal bore 21 and the orifice at the lower end of the valve stem 20 with the outside environment (at atmospheric pressure) or an external fan or air compressor. In the event of a leak in the zone of the outer circumferential edge 19 of the lower obturator plate 15, the considerable pressure difference means that flushing air flows out of the space 16 through the leak into the zone below the valve 10, such that carry-over of waste gases or waste air from the zone below the valve 10 into the space 16 may be prevented. In the event of a leak in the zone of the outer circumferential edge 18 of the upper obturator plate 14, flushing air will flow out from the space 16 via the leak into the zone above the valve 10, such that carry-over of waste gases or waste air from the zone above the valve 10 into the space 16 is prevented. All in all, according to the invention, carry-over of waste gases or waste air from the zone below (above) the valve 10 into the zone above (below) the valve 10 is thus prevented, and the valve 10 according to the invention thus continues to act as a hermetically sealing valve.

Due to gravity, dirt deposits, for example soot particles and the like, will preferably be deposited on the upward facing bevelled valve seat faces 13. Over long-term operation of the valve, such dirt deposits may likewise result in mechanical damage to the valve seat and/or the obturator, with the undesired consequence of valve leakage. Such dirt deposits on the bevelled valve seat face 13 may, however, be blown away by the flushing air which flows radially outwards from the space 16 when the valve is open. The flow speed of the flushing air emerging radially from the space 16 is substantially determined by the height of the space or gap 16. As the obturator is raised and lowered, the entire valve seat face 13, which contributes to the hermetic tightness of the valve 10, is uniformly flushed. In this manner, dirt deposits are removed effectively.

Vertical actuation of the obturator is described below with reference to FIGS. 4 to 6. According to the schematic front view of FIG. 5, a pedestal 41 is arranged below the gas inlet duct 4 and the gas outlet duct 5, on which pedestal is mounted a central drive shaft 40 (c.f. FIG. 1). As shown in FIG. 4, the rotary motive force of the drive shaft 40 is transferred via two inter meshing toothed wheels 42, 43 to the connecting rod 44 eccentrically coupled to the toothed wheel 43, which connecting rod is coupled to the connecting member 45, which is connected with a rocker arm 46, which is mounted swivellably about a pivot, which is located vertically above the center of rotation of the drive shaft 40 and of the toothed wheel 43, on the pedestal 41. As described above, the intrinsic weight of the obturator, of any weighting plates and of the valve stem are selected such that the lower end of the valve stem 20 rests permanently against the respective end of the rocker arm 46. When the rocker arm 46 rocks, the two associated valve stems 20 are thus actuated in opposite directions. If, for example, the rocker arm 46 rocks clockwise, the left hand valve stem 20 is raised, in order to open the associated valve, and the right hand valve stem 20 is lowered to an identical extent, in order to shut off the associated valve. The open position of the two valves associated with a particular pedestal 41 is unambiguously predetermined by the particular angular position of the connecting rod 44. By suitable arrangement of the connecting rods 44, the valves of the waste gas purification installation may be operated in a suitably cyclic manner in order suitably to shut off and control waste gas flow in the waste gas purification installation 1. The connecting rods 44 are very particularly preferably arranged offset at identical angular distances from one another, as is described in greater detail in EP 1 258 678 A2, the contents of which are explicitly incorporated by reference in the present application for the purposes of disclosure.

In the zones indicated by reference numbers 50 and 51 in FIG. 4 the valve stem 20 is mounted so as to be axially displaceable. Suitable bearing bushes (not shown) are provided for this purpose in the stated zones 50, 51. According to the invention, the valve stem 20 is furthermore mounted for rotation about its longitudinal axis in these bearing bushes, such that the valve stem 20 and obturator may jointly rotate about the longitudinal axis of the valve stem 20. On actuation of the valve 10, as is described in greater detail below, the valve stem 20 is also caused to rotate slowly about its longitudinal axis, such that, over long-term operation of the valve 10, it is not always the same zones of the bevelled valve seat face 13 and the outer circumferential edges 18, 19 of the two obturator plates 14, 15 which rest against one another, but these zones instead change. This results according to the invention in very uniform wear of the valve seat face 13 and of the outer circumferential edges 18, 19 and averts one-sided mechanical loads, overloading and the local formation of mechanical damage to the valve seat face and/or the outer circumferential edges 18, 19 in long-term operation.

As is shown in FIG. 4, the longitudinal axis of the valve stem 20 is offset relative to the center line of the connecting rod 44. The connecting member 44 or the contact zone on the top of the rocker arm 46 (not shown in FIG. 4) thus acts eccentrically on the cover plate 30 at the lower end of the valve stem 20. Frictional forces, which arise during raising and lowering of the valve stem 20 due to the sliding contact between the cover plate 30 and the connecting member 45 or the contact face on the top of the rocker arm (not shown in FIG. 4), induce torque which results in rotation of the valve stem 20 about its longitudinal axis. This torque may be enhanced by further measures. The top of the connecting member 45 or the contact face on the top of the rocker arm (not shown in FIG. 4) may accordingly be bevelled or curved and the underside of the cover plate 30 at the lower end of the valve stem 20 may be bevelled or oppositely curved. Alternatively, as is shown in FIG. 6, a roller 47 or rolling member may be mounted at the upper end of the connecting member 45 or at the top of the rocker arm (not shown in FIG. 6).

As will be quite obvious to the person skilled in the art from a study of the above description, numerous modifications may be made without deviating from the general concept of the solution and the scope of protection of the present invention, as claimed in the attached claims. Such modifications should accordingly explicitly be included within the scope of protection of the attached claims.

What is claimed as new desired to be secured by Letter Patent of the United States is:

1. A valve for a thermal-regenerative waste gas purification installation which valve may be installed in the connecting duct of the waste gas purification installation, the duct connecting a gas inlet duct or gas outlet duct for inlet or outlet of an untreated or treated waste gas with a treatment chamber, said valve having a conical valve seat and an obturator of corresponding shape, in order to close an orifice formed by the valve seat, said obturator being connected with a stem for actuation of the obturator, wherein:
said obturator comprises an upper obturator plate and a lower obturator plate, which are mounted spaced apart from one another; and
said stem comprises an axial internal bore, which is connected with a space formed between the obturator plates, in order to connect the space directly with the outside environment or with an external fan or air compressor.

2. The valve according to claim 1, wherein a lower end of the stem projects out from the gas inlet duct or gas outlet duct, wherein at the lower end an orifice is provided, in order to connect the internal bore with the outside environment or with the external fan or air compressor.

3. The valve according to claim 2, wherein the lower end of the stem comprises a cover plate, preferably of a hardened metal, and wherein the orifice is provided in the cover plate.

4. The valve according to claim 3, wherein a vertically movable actuating element is mounted close to the lower end of the stem, in order, in contact with the cover plate, to actuate the stem and the obturator, wherein the actuating element engages with the cover plate in such a manner that a rotational movement of the stem and of the obturator is effected on actuation.

5. The valve according to claim 4, wherein a roller or rolling member is provided at the top of the actuating element.

6. The valve according to claim 1, wherein at least one orifice, preferably a single orifice, is provided at an upper end of the stem in order to connect the internal bore with the space.

7. The valve according to claim 1, wherein the obturator plates comprise bevelled circumferential edges, in order, when in contact with an inner circumferential edge of the valve seat, to close the orifice formed in the valve seat.

8. The valve according to claim 1, wherein the obturator plates are rigidly connected to one another.

9. The valve according to claim 8, wherein the obturator plates are connected by means of a plurality of connecting elements, which are disposed within said space close to the outer circumferential edges of the obturator plates, preferably in a point-symmetrical arrangement relative to the stem.

10. The valve according to claim 1, wherein the space is annular in shape and spans the entire base area of the obturator plates, wherein the stem and a connecting element for connecting the stem with the obturator plates is arranged centrally.

11. The valve according to claim 1, wherein the ratio of the height of the space to the thickness of the obturator plates is less than 1, preferably distinctly less than 1.

12. The valve according to claim 4, wherein a support structure is associated with the actuating element, which structure is arranged below the associated gas inlet duct or gas outlet duct and on which a drive shaft is mounted, wherein a transmission is provided in order to convert a rotational movement of the drive shaft into a rocking motion of a rocker arm, which is mounted swivellably on the support structure and acts as an actuating element in order to cooperate with the lower end of the stem and to actuate the stem.

13. A thermal-regenerative waste gas purification installation, comprising at least one valve which is installed in a connecting duct of the waste gas purification installation, the duct connecting a gas inlet duct or gas outlet duct for inlet or outlet of an untreated or treated waste gas with an associated treatment chamber, said valve comprising a conical valve seat and an obturator of corresponding shape, in order to close an orifice formed by the valve seat, wherein:
said obturator is connected with a stem in order to actuate said obturator;
said obturator comprises an upper obturator plate and a lower obturator plate, which are mounted spaced apart from one another; and
said stem comprises an axial internal bore, which is connected with a space formed between the obturator plates, in order to connect the space directly with the outside environment or with an external fan or air compressor;
in which installation said valve is configured for closing and opening the associated orifice of the valve seat.

14. The thermal-regenerative waste gas purification installation according to claim 13, comprising at least two treatment chambers and associated valves in order to shut off or control a waste gas flow in the waste gas purification installation, wherein the valves are cyclically actuatable at identical angular distances over an angular range of 360 degrees.

15. The thermal-regenerative waste gas purification installation according to claim 14, which is operated at a pressure in said at least one treatment chamber of less than approx. 0.1 bar.
